(19) United States
(12) Patent Application Publication
(10) Pub. No.: US 2004/0150915 A1
(43) Pub. Date: Aug. 5, 2004

(54) Air bearing surface for a head, and a method of making it

(76) Inventors: Fred C. Thomas III, Ogden, UT (US); Jose Castillo, Layton, UT (US)

Correspondence Address: T. Murray Smith, Esq., Baker Botts L.L.P., 2001 Ross Avenue, Suite 600, Dallas, TX, 75201-2980, US

(21) Appl. No.: 10/359,500

(22) Filed: Feb. 5, 2003

(51) Int. Cl. G11B 5/60

(52) U.S. Cl. 360/235.8

(57) ABSTRACT

A head includes a bearing surface portion disposed between two transition surface portions which progressively diverge away from a plane containing the bearing surface portion. The bearing surface portion and transition surface portions collectively form a generally continuous surface which is substantially free of abrupt discontinuities in a head travel direction. A method of making the head involves use of a gray-scale mask to pattern a photoresist on a substrate, after which the photoresist is developed and the substrate is etched through the photoresist in order to create on the substrate a three-dimensional surface which includes the bearing surface portion and transition surface portions.

### TECHNICAL FIELD OF THE INVENTION

This invention relates in general to data storage technology and, more particularly, to a head for reading and/or writing data to or from a surface, and a method of making the head.

### BACKGROUND OF THE INVENTION

Over the past twenty years, computer technology has evolved very rapidly. One aspect of this evolution has been a progressively growing demand for increased storage capacity in memory devices, especially where the information storage media is disposed in some form of removable cartridge. In this regard, less than two decades ago, the typical personal computer had a floppy disk drive which accepted floppy disk cartridges that contained 5.25-inch disks having a storage capacity up to about 720 KB per cartridge. Not long thereafter, these devices gave way to a new generation of floppy disk drives, which accepted smaller floppy disk cartridges that contained 3.5-inch disks having higher storage capacities, up to about 1.44 MB per cartridge.

Subsequently, as the evolution continued, a further significant increase in storage capacity was realized by the introduction of a storage system having removable cartridges containing floppy-type disks with storage capacities on the order of 100 MB to 250 MB. Systems of this type are commercially available under the trademark ZIP® from Tomega Corporation of Roy, Utah, which is the Assignee of the present application. Thereafter, another significant increase in storage capacity was realized by the introduction of a system having removable cartridges with storage capacities on the order of 1 GB to 2 GB. Systems of this type are also available from Iomega Corporation, under the trademark JAZ®. The cartridges used in this system have a hard disk in an unsealed housing, with the read/write head in the drive. These two products have each enjoyed immense commercial success. Nevertheless, the demand for still greater storage capacity in removable cartridges continues to progressively increase, such that there is a current need for cartridges capable of storing 20 GB or more on a single disk having a diameter of about 2.5 inches.

The types of removable cartridges discussed above each contain a rotatably supported storage media within an unsealed housing. The read/write heads, with associated circuitry and support structure, are in the drive rather than in the cartridge. Significantly higher storage capacities exist in hard disk technology of the type used in non-removable hard disk drives, where the disk and read/write head are both disposed within a sealed housing. However, if a read/write head and its associated support structure are provided in every cartridge, the cost of each cartridge becomes relatively high, in comparison to unsealed cartridges which contain only a rotatable disk. Consequently, there is a need for substantially higher storage capacities in cartridges of the type that have a disk in an unsealed housing.

Where the cartridge housing is not sealed, one significant consideration is that the disk in the cartridge and the head in the drive are both exposed to environmental debris, such as airborne dust and vapors. Over time, this environmental debris can accumulate in recesses or pockets that may be present in the read/write head, thereby leading to a degradation in the performance of the head, even to the point where the head may be inoperative. Frequent cleaning or other maintenance may help to some extent, but is undesirable, and in any event has to be carefully designed. The traditional way of compensating for this accumulation of debris was to keep data storage densities at relatively low levels. Stated differently, previous technologies allowed more particles and debris because the data storage densities were relatively low and the head technology allowed some contact between the head and the disk. However, as discussed above, the demand for higher storage densities is becoming progressively stronger, and there is thus a growing need for a head which is less susceptible to environmental debris when used in an unsealed housing.

A separate consideration is that existing heads often have air bearing surfaces with edges that can damage the magnetic layer on the disk if the head should happen to engage the disk as a result of a mechanical shock. Further, these edges are subject to cracking or chipping when subjected to a cleaning process, thereby producing chips or fragments of the head that can damage the magnetic layer on the disk.

The edges on the heads, as well as the pockets that collect debris, exist in part because of limitations in the existing techniques for fabricating these heads. More specifically, these heads have traditionally been fabricated using two or more high-contrast photolithographic masks, which produce the problematic edges and recesses. Further, the use of two or more masks leads to a need for accurate alignment, which is difficult, time consuming, and adds significantly to the fabrication cost. In this regard, it should be remembered that, as storage densities have progressively increased, magnetic heads have progressively decreased in size.

### SUMMARY OF THE INVENTION

From the foregoing, it may be appreciated that a need has arisen for a method and apparatus that help to mitigate effects of environmental debris with respect to a magnetic head and storage media.

One form of the invention relates to a method for making a head, and involves: providing a substrate and forming a three-dimensional surface configuration on the substrate, where forming the three-dimensional surface involves: applying a layer of a photoresist on a surface of the substrate; directing radiation onto the photoresist through a gray-scale mask which embodies a gray-scale pattern, the gray-scale pattern being transferred to the photoresist; selectively removing portions of the photoresist in a manner conforming to the gray-scale pattern; and etching the substrate through the photoresist to selectively remove material of the substrate in a manner defining on the substrate the three-dimensional surface configuration, the surface configuration including an approximately planar bearing surface portion which extends approximately parallel to a first direction representing a head travel direction, and which faces in a second direction approximately perpendicular to the first direction.

A different form of the invention relates to a magnetic head which includes: an approximately planar bearing surface portion which extends approximately parallel to a first direction representing a head travel direction, the bearing surface portion facing in a second direction approximately perpendicular to the first direction; and first and second transition surface portions disposed on opposite sides of the bearing surface portion along the first direction, each transition surface portion extending away from the bearing surface portion in a manner so as to progressively diverge away from a plane containing the bearing surface portion in a direction opposite to the second direction, the bearing surface portion and the transition surface portions collectively forming a substantially continuous surface which is substantially free of abrupt discontinuities along the first direction.

### BRIEF DESCRIPTION OF THE DRAWINGS

A better understanding of the present invention will be realized from the detailed description which follows, taken in conjunction with the accompanying drawings, in which:

FIG. 1 is a diagrammatic view of an apparatus which is an information storage device, and which embodies aspects of the present invention;

FIG. 2 is a diagrammatic fragmentary perspective view of a pre-existing magnetic read/write head;

FIG. 3 is a diagrammatic fragmentary perspective view of a magnetic read/write head which is a component of the information storage device of FIG. 1, and which embodies aspects of the present invention;

FIG. 4 is a diagrammatic fragmentary perspective view of a ceramic bar having thereon a photoresist layer and a photolithographic mask, representing an intermediate step during the manufacture of the read/write head of FIG. 3; and

FIG. 5 is a flowchart showing a sequence of steps involved in the fabrication of the read/write head of FIG. 3.

### DETAILED DESCRIPTION OF THE INVENTION

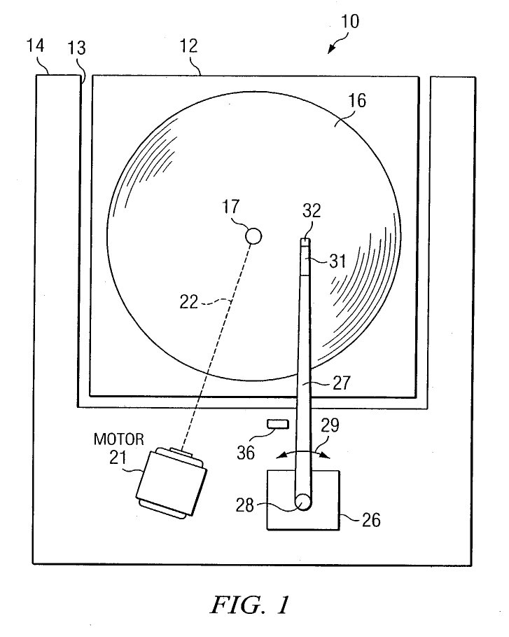

FIG. 1 is a diagrammatic view of an apparatus which is an information storage device 10, and which embodies aspects of the present invention. The information storage device 10 includes an information storage cartridge 12, which is removably inserted into a recess 13 in a receiving unit 14. The receiving unit 14 can also be referred to as a drive or cradle.

The cartridge 12 has a spindle 17 which is rotatably supported within a housing, and has a hard disk 16 mounted on the spindle 17 for rotation therewith. When the cartridge 12 is removably disposed in the drive 14, a spindle motor 21 in the drive 14 is drivingly coupled to the spindle 17 by a coupling mechanism of a known type. Thus, the motor 21 can effect rotation of the spindle 17 and disk 16. Although the disk 16 in FIG. 1 is a hard disk, it could alternatively be a flexible or “floppy” disk.

The hard disk 16 includes a rigid substrate which is made of a known glass, but which could alternatively be made of some other suitable known material, such as aluminum. On the side of the disk 16 which is visible in FIG. 1, the disk 16 has a layer of a known magnetic material, where digital information can be magnetically stored. For simplicity and convenience, it is assumed that there is only a single disk 16 on the spindle 17, and that the disk 16 has the magnetic layer on only one side thereof. However, it would alternatively be possible to provide two or more disks on the spindle 17, and/or to provide a layer of the magnetic material on one or both sides of each disk.

The drive 14 includes an actuator 26 of a known type. An actuator arm 27 is fixedly coupled at one end to a pivot pin 28 of the actuator 26. Thus, the actuator 26 can effect pivotal movement of the pivot pin 28 and the arm 27, as indicated diagrammatically by a double- headed arrow 29. At its outer end, the arm 27 carries a suspension 31 of a known type, which in turn supports a read/write head 32. The head 32 is a type of read/write head commonly referred to as a giant magneto-resistive (GMR) head. During normal operation, the head 32 is disposed closely adjacent the magnetic layer on the disk 16. In this regard, it is commonly said that the head is “flown” close to the magnetic layer on the disk.

With reference to FIG. 1, pivotal movement of the arm 27 effects movement of the head 32 in directions approximately radially of the disk 16, between a position in which the head 32 is near the spindle 17, and a position in which the head 32 is near an outer edge of the disk 16. During normal operation, the disk 16 is continuously rotated by the motor 21. Consequently, through pivotal movement of the arm 27 and rotation of the disk 16, the head 32 can be selectively positioned in alignment with any point on the operational surface of the disk. The head 32 can be used to write digital information to or read digital information from the magnetic layer defining the surface of disk 16.

The drive 14 includes an inclined ramp 36. As the arm 27 pivots counterclockwise in FIG. 1, and as the head 32 thus approaches the spindle 17, the arm 27 engages and slides up on the ramp 36. The ramp 36 urges the arm 27 away from the disk 16, thereby effecting movement of the outer end of the arm 27 away from the disk 16, so that the head 32 is moved away from the disk. This is known as the park position of the arm 27 and disk 32, and serves to keep the head 32 spaced from the disk 16, except when the cartridge 12 is disposed in the drive 14, in order to prevent physical damage to the head 32 and/or the magnetic layer on the disk 16. Although FIG. 1 shows the ramp 36 positioned so that the arm 27 engages the ramp 36 as the arm pivots counterclockwise and the head 32 moves toward the spindle 17, it will be recognized that the ramp 36 could alternatively be positioned so that the arm 27 engages the ramp 36 as the arm pivots clockwise and the head 32 moves toward the edge of the disk 16.

During normal operation, when the arm 27 is not engaging the ramp 36, the head 32 is located closely adjacent the disk 16. However, the head 32 does not physically engage the disk 16. Instead, when the disk 16 is rotating at a normal operational speed, the rotation of the disk generates an air cushion or “air bearing” between the disk 16 and the head 32. Consequently, the head 32 floats on the air bearing while reading and writing information to and from the disk 16, without direct physical contact with the disk. In this manner, the head “flies” at a relatively constant distance from the disk. The head 32 has, on a side thereof facing the disk 16, an air bearing surface (ABS), which is discussed later and which facilitates generation of the air cushion between head 32 and disk 16.

In order to achieve a high data storage density on a magnetic disk, one existing type of disk drive system places the disk, the actuator, the actuator arm and the magnetic head within a hermetically sealed housing. The sealed housing protects the disk and head from environmental debris such as airborne dust and vapors. Since this debris cannot reach the disk and head, it cannot contaminate and/or damage the disk and/or head. (Of course, as is known in the art, internal debris can be generated in such a sealed system by undesired head-media contact during operation, starts or stops, for example due to physical shock).

The apparatus 10 of FIG. 1 is somewhat different, in that the disk 16, actuator 26, arm 27 and head 32 are not disposed within a hermetically sealed housing. Instead, the housing of the cartridge 12 has a not-illustrated opening which permits the arm 27 and head 32 to move into the cartridge housing as the cartridge 12 is inserted into the drive 14. This is advantageous from an economic perspective, because it avoids the expense which would be involved in providing an actuator, arm and head in each and every cartridge 12. On the other hand, it allows the disk 16 and the head 32 to be exposed to environmental debris, such as airborne dust and vapors.

In pre-existing devices where the disk and head are exposed to environmental debris, the amount of data which can be reliably stored on the disk is significantly lower than for a pre-existing device of the type where the disk and head are disposed within a sealed housing. In these pre-existing devices, the amount of data that can be reliably stored per unit area is approximately ten times greater where the disk and head are inside a sealed housing than where the disk and head are exposed to environmental debris.

One aspect of the present invention is that the head 32 is configured so as to mitigate the adverse effects of environmental contaminants such as vapors and dust that may enter the unsealed housing of the cartridge 12. As a result, the head 32 permits a substantial increase in the amount of data which can be reliably stored per unit area on the disk 16, in comparison to pre-existing systems in which the disk and head are in an unsealed housing.

Before providing a detailed explanation of the structure of the head 32, it will be helpful to briefly discuss a pre-existing head. In this regard, FIG. 2 is a diagrammatic fragmentary perspective view of part of a pre-existing head 51, which has on one side thereof a three-dimensional air bearing surface (ABS) 52. For clarity, FIG. 2 is not to scale. In particular, vertical dimensions are greatly exaggerated in comparison to horizontal dimensions. During normal operation, the ABS 52 faces and is closely adjacent the magnetic layer on a rotating disk. The arrow 53 indicates the direction in which the disk moves relative to the head 51, due to the rotation of the disk.

The ABS 52 includes a base surface portion 56, and four intermediate surface portions 61-64 which, in FIG. 2, are spaced upwardly from the base surface portion 56. The ABS 52 also include three upper surface portions 67-69, which are spaced upwardly from the intermediate surface portions 61-64. The upper surface portions 67-69 are the portions of the ABS 52 which are closest to the disk during normal operation. The ABS 52 further includes a number of side surface portions. For example, there are side surface portions 71-75 which each extend between the base surface portion 56 and one of the intermediate surface portions 61-64, and there are side surface portions 76-82 which each extend between one of the intermediate surface portions 61-64 and one of the upper surface portions 67-69. As noted above, vertical dimensions in FIG. 2 are greatly exaggerated in comparison to horizontal dimensions. Consequently, certain surfaces appear to be more vertical or more steeply inclined than is actually the case. As one example, each of the surfaces 71-82 actually extends at an angle in the range of about 2° to 20° with respect to a horizontal reference, but in FIG. 2 these surfaces each appear to be inclined more steeply.

It will be noted that, with reference to the direction 53 of movement of the disk with respect to the head 51, the upper surface portions 67-69 have leading and trailing edges 91-96 which are each a well defined corner. These edges present the potential for damage to the disk and/or the head 51. For example, if the head 51 is provided in an apparatus of the type shown at 10 in FIG. 1, and if this apparatus experiences a mechanical shock during operational use, the head 51 might actually contact the disk despite the presence of the air cushion, and one or more of the relatively sharp edges 91-96 could scrape or otherwise damage the magnetic layer on the disk 16, thereby resulting in a loss of data. As another example, the head 51 may engage the disk when it is moved from its park position to an operational position, in particular as the actuator arm which supports the head 51 moves off the ramp that lifts the arm and head away from the disk in the park position.

A further consideration is that, since the edges 91-96 are relatively sharp corners, they are subject to cracking and/or chipping, due to engagement with the disk, or due to engagement with some form of relatively rough cleaning material during maintenance. Even the smallest fragments that break away from these edges can serve as highly destructive debris, due to the hardness of the material from which the head is fabricated. Fragments of this type are likely to scratch the magnetic layer on the disk, and could potentially damage the head 51.

The sidewalls define a number of corners or recesses, some of which are indicated by reference numerals 101-109. Over time, these recesses are susceptible to accumulation of dust, smoke particles and other airborne debris, and the progressive accumulation of such contamination eventually begins to interfere with proper operation of the head 51.

Depending on the shape of the head 51 and its ABS 52, it may be possible to mechanically bevel a small subset of the edges 91-96. However, this is typically possible only at the periphery of the ABS 52. Further, it is time consuming and expensive, and very difficult to control with the needed precision. It is typically not possible or practical to bevel all of the edges 91-96. Moreover, such mechanical milling techniques cannot resolve problems associated with recesses of the type indicated at 101-109.

Well-defined edges, such as those indicated at 91-96, and well-defined recesses, such as those indicated at 101-109, are due to limitations of the existing techniques used to create the ABS 52 on the head 51, and in particular are characteristics that inherently result when pre-existing manufacturing technologies are used in a manner that assures a repeatable manufacturing process. In more detail, the ABS 52 is formed by (1) applying a layer of a known photoresist material to a surface of the head, (2) successively using two or more distinct masks to pattern the photoresist, (3) chemically developing the photoresist in order to remove unwanted portions, and (4) then etching the material of the head 51 through the remaining photoresist.

In this regard, one mask is used to define the base surface portion 56, and a different mask is used to define the intermediate surface portions 61-64. These masks are existing types of photolithographic masks known as high contrast masks, in that each point in each mask is either substantially transparent or substantially opaque to the radiation which patterns the photoresist. The transitions between opaque and transparent regions are thus pronounced, and result in the creation of well-defined edges and/or corners of the type discussed above. At the transitions in the mask, an optical effect such as diffraction may impart a degree of inclination to surfaces on one or both sides of the resulting edge or corner, but the abrupt transitions in the mask nevertheless produce well-defined edges or corners.

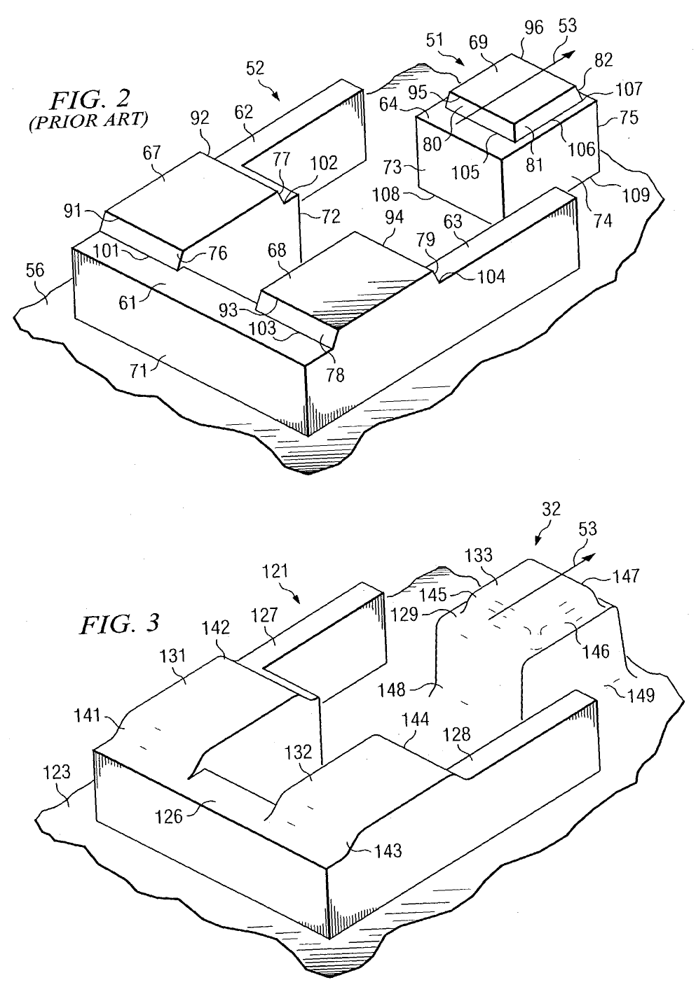

Turning again to the head 32 of FIG. 1, FIG. 3 is a diagrammatic fragmentary perspective view of part of the head 32, and in particular shows a three-dimensional ABS 121 which is on the side of head 32 that faces the disk 16. The ABS 121 shown in FIG. 3 is exemplary, and the invention is compatible with a variety of other surface configurations. The exemplary ABS 121 of FIG. 3 has a base surface portion 123, intermediate surface portions 126-129 which are offset upwardly from the base surface portion 123, and upper surface portions 131-133 which are offset upwardly from the intermediate surface portions 126-129.

The ABS 121 has a number of transition surface portions, several of which are identified by reference numerals 141-149. The transition surface portions do not meet adjacent surfaces at a well-defined edge or corner. Instead, the transition surface portions merge into adjacent surfaces with a smooth or “blended” transition which does not have well-defined edges or corners. This is particularly true in relation to the direction of movement 53 of the disk 16 in relation to the head 32. For example, the upper surface portion 131 does not have defined corners at its leading and trailing edges, but instead merges smoothly and continuously into transition surface portions 141-142, which then merge smoothly and continuously into respective intermediate surface portions 126 and 127. Consequently, the leading and trailing edges of upper surface portion 132 do not have well-defined corners, and thus have little susceptibility to chipping that could produce fragments capable of physically damaging the disk 16. Moreover, where the transition surface portions 141 and 142 merge into the intermediate surface portions 126 and 127, there are no well-defined inside corners, which has the effect of reducing the likelihood that dust or other debris can easily accumulate in a manner leading to impairment of the operation or performance of the head 32.

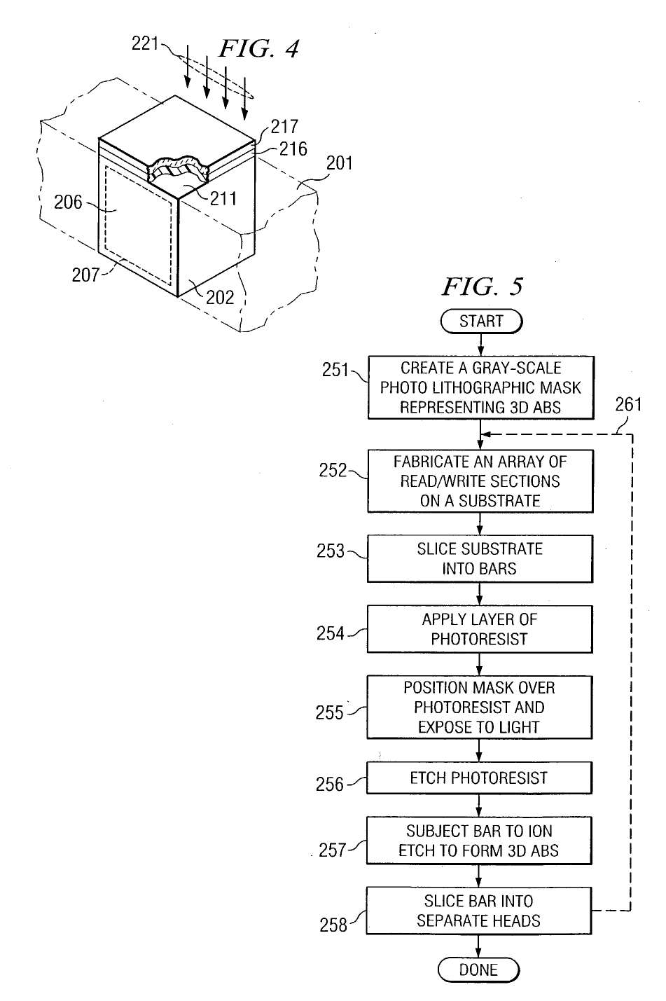

One aspect of the present invention is a technique for fabricating the ABS 121. In this regard, FIG. 4 is a diagrammatic perspective view showing a strip or bar 201 which is made of a known ceramic material that is commonly used in the industry as a substrate for read/write heads. For example, the bar 201 can be made of alumina titanium carbide.

Reference numeral 202 designates a section of the bar 201. After some processing steps which are described below, the section 202 of the bar 201 will become part of the head 32 of FIGS. 1 and 3. The bar 201 actually includes a plurality of sections which are each similar to the section 202, and all of these sections are processed at the same time. However, for convenience and clarity, only the section 202 is shown and described in detail.

The section 202 of the bar 201 has a side surface 206. Through a series of processing steps which are known in the art, inductive read/write structure is formed on the side surface 206, as indicated diagrammatically by a broken line 207 in FIG. 4.

Next, a layer 216 of a low-contrast photoresist is deposited on a top surface 211 of the section 202. The layer 216 actually extends the full length of the bar 201, but for clarity FIG. 4 shows only the portion on top of the section 202. A gray-scale photolithographic mask 217 is then positioned over the photoresist 216. The mask 217 embodies a photolithographic gray-scale pattern which is representative of the topography of the ABS 121 of FIG. 3. The mask 217 differs from the photolithographic masks traditionally used to make magnetic heads, in that the mask 217 has a low contrast, because the transmissivity of the mask can vary progressively across the mask. In addition, the mask 217 has a very high spatial resolution. Suitable technology for making the mask 217 is commercially available from Canyon Materials, Inc. of San Diego, Calif.

One type of mask material available from Canyon Materials is called a high energy beam sensitive (HEBS) glass, and another is called a laser direct write (LDW) glass. Each of these materials is a chemically doped glass, which can be mastered to create a gray-scale mask with variable transmissivity and high spacial resolution. The HEBS glass is mastered using an electron beam. The LDW glass is mastered using an optical laser beam stylus. Both types of glass have an inherent resolution which is on the order of molecular dimensions, and thus the resolution of the resulting mask is determined by the diameter of the electron beam or laser beam used to master the glass. For example, in the case of HEBS glass, an electron beam can theoretically have a diameter as small as about 5 nanometers, but as a practical matter there are scattering considerations which presently limit the effective resolution of the mask to about 100 nanometers. HEBS glass and LDW glass are merely two examples of suitable types of gray-scale photolithographic mask. It would alternatively be possible to use any other suitable gray-scale mask.

Next, with reference to FIG. 4, radiation is directed through the mask 217 and onto exposed portions of the photoresist 216, in order to transfer to photoresist 216 the gray-scale pattern embodied in the mask 217. The mask 217 is then removed, and the photoresist is chemically etched in order to selectively remove portions of the photoresist 216 in a manner conforming to the pattern received from the mask 217. Thus, there will be some regions in which the entire thickness of the photoresist 216 is removed so as to expose a portion of the surface 211, other regions in which very little of the photoresist 216 is removed, and still other regions in which the thickness changes progressively across the region.

After the photoresist has been etched, the bar 201 with the remaining portion of the photoresist 216 is subjected to an ion etch or a reactive ion etch, which has the effect of etching the top surface 211 of the section 202 so as to form a three-dimensional surface that corresponds to the pattern embodied in the photoresist 216. In the disclosed embodiment, this three-dimensional surface is the ABS 52 shown in FIG. 3. After the ion etching or reactive ion etching, remaining portions of the photoresist 216 are removed, and the bar 201 is then sliced up so as to separate the sections of the bar from each other. Section 202 serves as the head 32 which is shown in FIGS. 1 and 3.

FIG. 5 is a flowchart showing the sequence of steps which is carried out in order to fabricate the head 32. At block 251, the gray-scale photolithographic mask 217 is fabricated. At block 252, a two-dimensional array of read/write sections 207 is fabricated on a platelike wafer or substrate. At block 253, the platelike substrate is sliced into a plurality of row bars, which each have a plurality of the read/write sections 207 disposed therealong. The bar shown at 201 in FIG. 4 is one of these bars.

Next, at block 254, the photoresist layer 216 is applied to each bar. At block 255, the mask 217 is positioned over the photoresist, and is then exposed to radiation 221 in order to pattern the photoresist according to the mask. The mask is then removed and, at block 256, the photoresist 216 is developed, for example by chemical etching, in order to selectively remove photoresist material in a manner corresponding to the gray-scale pattern embodied in the mask. Then, at block 257, the bar is subjected to ion etching or reactive ion etching, in order to remove material of the section 202 and thereby form the three-dimensional ABS 121 (FIG. 3). Next, at block 258, each bar is sliced into separate sections or sliders, where each section includes a respective read/write head with the desired air bearing surface. As shown diagrammatically by the broken line 261, it is possible to repeat the process of FIG. 5 with a different wafer, but using the same gray-scale mask which was created at block 251.

The sequence shown in FIG. 5 is one possible sequence, and it will be recognized that the order of some of the steps in FIG. 5 could be varied. Further it, will be recognized that there are other alternative sequences which are encompassed by the present invention.

The present invention provides a number of technical advantages. One such advantage is the provision of a read/write head with an air bearing surface that has upper portions which are substantially free of defined edges or corners. Consequently, there is reduced likelihood of damage to the head or a magnetic disk in the event that the head happens to come into physical contact with the disk, for example due to a mechanical shock. Further, the head according to the invention has a reduced likelihood of chipping or cracking in a manner that would produce fragments capable of damaging the head or the magnetic disk. Although the head in the disclosed embodiment is an electromagnetic head, the present invention can be used for other applications, such as a read or write head that transfers data optically, or a burnishing head which is used to polish a magnetic disk.

Still another consideration is that the bearing surface does not have defined pockets or corners at certain locations, and is thus less likely to accumulate dust and other debris in a manner that could affect the performance of the head. This gives the head an added degree of resistance to environmental debris such as airborne dust and vapors, which in turn permits the head to achieve significantly higher data storage densities than pre-existing systems for an unsealed environment. Yet another advantage is that the bearing surface can help to reduce the likelihood of media thermal erasures and/or thermal asperities during a data read.

Still another advantage flows from the provision of a process for making the read/write heads, in which a gray-scale mask is used to define the topography of an air bearing surface on the head. A relatively sophisticated air bearing surface can be created using a single mask, thereby avoiding alignment problems of the type involved with the multiple masks used in pre-existing approaches. The use of a single gray-scale mask also reduces the manufacturing cost of the resulting head in other ways, for example by reducing the number of process steps needed to realize a particular photolithographic pattern in a given layer of photoresist material.

Although a selected embodiment has been illustrated and described in detail, it will be understood that various substitutions and alterations are possible without departing from the spirit and scope of the present invention, as defined by the following claims.

What is claimed is:

1. A method of making a head, comprising the steps of:
providing a substrate; and
forming a three-dimensional surface configuration on said substrate, including the steps of:
applying a layer of a photoresist on a surface of said substrate;
directing radiation onto said photoresist through a gray-scale mask which embodies a gray-scale pattern, said gray-scale pattern being transferred to said photoresist;
selectively removing portions of said photoresist in a manner conforming to said gray-scale pattern; and
etching said substrate through said photoresist to selectively remove material of said substrate in a manner defining on said substrate said three-dimensional surface configuration, said surface configuration including an approximately planar bearing surface portion which extends approximately parallel to a first direction representing a head travel direction, and which faces in a second direction approximately perpendicular to said first direction.

2. A method according to claim 1, wherein said etching step causes said three-dimensional surface to include first and second transition surface portions disposed on opposite sides of said bearing surface portion along said first direction, each said transition surface portion extending away from said bearing surface portion in a manner so as to progressively diverge away from a plane containing said bearing surface portion in a direction opposite to said second direction, said bearing surface portion and said transition surface portions collectively forming a substantially continuous surface which is substantially free of abrupt discontinuities along said first direction.

3. A method according to claim 1, wherein said etching step causes said three-dimensional surface to include a further planar bearing surface portion which extends approximately parallel to said first direction and faces substantially in said second direction, and to include third and fourth transition surface portions disposed on opposite sides of said further bearing surface portion along said first direction, each of said third and fourth transition surface portions extending away from said further bearing surface portion in a manner so as to progressively diverge away from a plane containing said further bearing surface portion in a direction opposite to said second direction, said further bearing surface portion and said third and fourth transition portions collectively forming a substantially continuous surface which is substantially free of abrupt discontinuities along said first direction.

4. A method according to claim 1, wherein said etching step causes said three-dimensional surface to include third and fourth transition surface portions disposed on opposite sides of said bearing surface portion along a third direction perpendicular to said first and second directions, each of said third and fourth transition surface portions extending away from said bearing surface portion in a manner so as to progressively diverge away from said plane containing said bearing surface portion in a direction opposite to, said second direction, said bearing surface portion and said third and fourth transition portions collectively forming a substantially continuous surface which is substantially free of abrupt discontinuities along said third direction.

5. A method according to claim 1, wherein said etching step causes said three-dimensional surface to include two further surface portions which each face substantially in said second direction, each of said transition surface portions, at a side thereof remote from said bearing surface portion, merging into a respective said further surface portion, said bearing surface portion being offset in said second direction from each of said further surface portions, and said bearing surface portion, said transition portions, and said further surface portions collectively forming a substantially continuous surface which is substantially free of abrupt discontinuities along said first direction.

6. A method according to claim 5, wherein said etching step causes said three-dimensional surface to include:
a base surface portion which faces substantially in said second direction, said further surface portions being offset in said second direction from said base surface portion;
a side surface portion extending at an angle with respect to said base surface portion and one of said further surface portions; and
a further transition surface portion which merges smoothly into each of said base surface portion and said one of said further surface portions, said base surface portion, said further transition surface portion and said one of said further surface portions collectively forming a substantially continuous surface which is substantially free of abrupt discontinuities along said first direction.

7. A method according to claim 1, wherein said step of providing said substrate includes the step of selecting a ceramic material for use as said substrate.

8. A method according to claim 1, including the step of selecting a chemically doped glass material with variable transmissivity and high spatial resolution for use as said gray-scale mask.

9. A method according to claim 1, including the step of selecting a high energy beam sensitive glass for use as said gray-scale mask.

10. A method according to claim 1, including the step of selecting a laser direct write glass for use as said gray-scale mask.

11. A method according to claim 1, including the step of forming structure on said substrate which is capable of effecting a data transfer relative to said head.

12. A method according to claim 11, wherein said step of forming structure on said substrate is carried out so that said structure is capable of electromagnetically effecting a data transfer relative to said head.

13. An apparatus comprising a head which includes:
an approximately planar bearing surface portion which extends approximately parallel to a first direction representing a head travel direction, said bearing surface portion facing in a second direction approximately perpendicular to said first direction; and
first and second transition surface portions disposed on opposite sides of said bearing surface portion along said first direction, each said transition surface portion extending away from said bearing surface portion in a manner so as to progressively diverge away from a plane containing said bearing surface portion in a direction opposite to said second direction, said bearing surface portion and said transition surface portions collectively forming a substantially continuous surface which is substantially free of abrupt discontinuities along said first direction.

14. An apparatus according to claim 13, wherein said head includes a further planar bearing surface portion which extends approximately parallel to said first direction and faces substantially in said second direction, and includes third and fourth transition surface portions disposed on opposite sides of said further bearing surface portion along said first direction, each of said third and fourth transition surface portions extending away from said further bearing surface portion in a manner so as to progressively diverge away from a plane containing said further bearing surface portion in a direction opposite to said second direction, said further bearing surface portion and said third and fourth transition portions collectively forming a substantially continuous surface which is substantially free of abrupt discontinuities along said first direction.

15. An apparatus according to claim 13, wherein said head includes third and fourth transition surface portions disposed on opposite sides of said bearing surface portion along a third direction perpendicular to said first and second directions, each of said third and fourth transition surface portions extending away from said bearing surface portion in a manner so as to progressively diverge away from said plane containing said bearing surface portion in a direction opposite to said second direction, said bearing surface portion and said third and fourth transition portions collectively forming a substantially continuous surface which is substantially free of abrupt discontinuities along said third direction.

16. An apparatus according to claim 13, wherein each of said transition surface portions, at a side thereof remote from said bearing surface portion, merges into a respective further surface portion which faces substantially in said second direction, said bearing surface portion being offset in said second direction from each of said further surface portions, and said bearing surface portion, said transition portions, and said further surface portions collectively forming a substantially continuous surface which is substantially free of abrupt discontinuities along said first direction.

17. An apparatus according to claim 16, wherein said head includes:
a base surface portion which faces substantially in said second direction, said further surface portions are offset in said second direction from said base surface portion;
a side surface portion extending at a sharp angle with respect to said base surface portion and one of said further surface portions; and
a further transition surface portion which merges smoothly into each of said base surface portion and said one of said further surface portions, said base surface portion, said further transition surface portion and said one of said further surface portions collectively forming a substantially continuous surface which is substantially free of abrupt discontinuities along said first direction.

18. An apparatus according to claim 13, wherein said head includes a ceramic substrate which has each of said surface portions thereon.

19. An apparatus according to claim 13, wherein said bearing surface portion is an air bearing surface portion.

20. An apparatus according to claim 13, wherein said head is a read/write head.

21. An apparatus according to claim 13, including structure capable of effecting a data transfer relative to said head.

22. An apparatus according to claim 21, wherein said structure is capable of electromagnetically effecting a data transfer relative to said head.
